(19) United States
(12) Patent Application Publication
(10) Pub. No.: US 2025/0351118 A1
(43) Pub. Date: Nov. 13, 2025

(54) TECHNIQUES FOR ADAPTING PAGING EARLY INDICATION CONFIGURATIONS BASED ON ADAPTATIONS TO PAGING CONFIGURATIONS

(71) Applicant: QUALCOMM Incorporated, San Diego, CA (US)

(72) Inventors: Ahmed Attia ABOTABL, San Diego, CA (US); Navid ABEDINI, Basking Ridge, NJ (US)

(21) Appl. No.: 18/657,651

(22) Filed: May 7, 2024

(51) Int. Cl. H04W 68/00; H04W 52/02

(52) U.S. Cl. CPC H04W 68/005; H04W 52/0229

(57) ABSTRACT

Methods, systems, and devices for wireless communications are described. A user equipment (UE) may receive a first control message indicating a first paging configuration associated with a first paging cycle and may receive a first paging early indication (PEI) associated with the first paging cycle in accordance with a first PEI parameter set based on the first paging configuration. The UE may determine whether to update the first PEI parameter set for a second PEI associated with a second paging cycle based on updating the first paging configuration. In some cases, the UE may determine not to update the first PEI parameter set and may receive the second PEI in accordance with the first PEI parameter set. In some other cases, the UE may determine to update the first PEI parameter set and may receive the second PEI in accordance with a second PEI parameter set.

### FIELD OF TECHNOLOGY

The following relates to wireless communications, including techniques for adapting paging early indication (PEI) configurations based on adaptations to paging configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for adapting paging early indication (PEI) configurations based on adaptations to paging configurations in accordance with one or more aspects of the present disclosure.

FIG. 2 shows an example of a wireless communications system that supports techniques for adapting PEI configurations based on adaptations to paging configurations in accordance with one or more aspects of the present disclosure.

FIG. 3 shows an example of a process flow that supports techniques for adapting PEI configurations based on adaptations to paging configurations in accordance with one or more aspects of the present disclosure.

FIGS. 4 and 5 show block diagrams of devices that support techniques for adapting PEI configurations based on adaptations to paging configurations in accordance with one or more aspects of the present disclosure.

FIG. 6 shows a block diagram of a communications manager that supports techniques for adapting PEI configurations based on adaptations to paging configurations in accordance with one or more aspects of the present disclosure.

FIG. 7 shows a diagram of a system including a device that supports techniques for adapting PEI configurations based on adaptations to paging configurations in accordance with one or more aspects of the present disclosure.

FIGS. 8 and 9 show block diagrams of devices that support techniques for adapting PEI configurations based on adaptations to paging configurations in accordance with one or more aspects of the present disclosure.

FIG. 10 shows a block diagram of a communications manager that supports techniques for adapting PEI configurations based on adaptations to paging configurations in accordance with one or more aspects of the present disclosure.

FIG. 11 shows a diagram of a system including a device that supports techniques for adapting PEI configurations based on adaptations to paging configurations in accordance with one or more aspects of the present disclosure.

FIGS. 12 and 13 show flowcharts illustrating methods that support techniques for adapting PEI configurations based on adaptations to paging configurations in accordance with one or more aspects of the present disclosure.

### DETAILED DESCRIPTION

In some wireless communications systems, wireless devices, such as user equipment's (UEs) and network entities, may support paging. That is, a UE may operate according to a paging cycle, which may also be referred to as a discontinuous reception (DRX) cycle, in which the UE may enter an idle, or sleep, mode, and may wake up periodically to receive paging messages from a second wireless device, such as a network entity. In such cases, to indicate to the UE when to wake up to receive one or more paging messages, the network entity may transmit a paging early indication (PEI). That is, the UE may periodically wake up (e.g., enter an active, or connected, mode) during a paging cycle to measure one or more reference signals, such as synchronization signal blocks (SSBs), to perform time and frequency synchronization (e.g., with the network entity) and the network entity may transmit a PEI subsequent to (e.g., immediately after) a reference signal of the one or more reference signals while the UE is still awake. In such cases, the PEI may indicate one or more paging occasions (POs) during which the network entity may transmit one or more paging messages, such that the UE may return to the idle mode (e.g., after receiving the PEI) and may wake up during the one or more POs to receive the one or more paging messages. Thus, the PEI may be associated with a PEI configuration indicating one or more parameters, which may be referred to as PEI parameters, that enable the UE to determine how information indicated in the PEI corresponds to the paging cycle.

In some cases, to support network energy savings, network entities and UEs may support dynamic updates (e.g., adaptations) of paging configurations. That is, a paging configuration may indicate one or more parameters associated with a paging cycle, such as a quantity of paging frames (PFs) in the paging cycle, a quantity of POs per PF, a duration of the paging cycle, or the like thereof, and the UE may update the paging configuration dynamically (e.g., based on control signaling or autonomously). However, one or more parameters PEI parameters associated with a PEI configuration for a PEI may be based on (e.g., match) a paging configuration associated with a paging cycle for which the PEI is transmitted. For example, the PEI may indicate a first quantity of POs in one or two consecutive PFs, where the first quantity is based on a total quantity of POs in the associated paging cycle. Thus, the UE may be unaware of how or if to update a PEI configuration based on a dynamic update to a paging configuration.

Accordingly, techniques described herein may support determining whether to update a PEI configuration based on a dynamic update to a paging configuration. For example, in some cases, a UE may refrain from updating (e.g., autonomously updating) a PEI configuration based on an update to a paging configuration. Alternatively, the UE may update (e.g., autonomously update) a PEI configuration based on an update to a paging configuration. For example, the UE may update one or more PEI parameters of the PEI configuration to match one or more parameters of the updated paging configuration (e.g., until a threshold value is reached). Additionally, or alternatively, the UE may update one or more PEI parameters of the PEI configuration based on a set of mappings between PEI configurations and paging configurations. That is, each paging configuration may correspond to a PEI configuration, such that when a first paging configuration is updated to a second paging configuration, the UE updates a first PEI configuration mapped to the first paging configuration to a second PEI configuration mapped to the second paging configuration. Additionally, or alternatively, the UE may update one or more PEI parameters of the PEI configuration based on one or more rules. For example, a rule of the one or more rules may define that if a quantity of POs associated with a paging cycle is increased (e.g., based on an update to an associated paging configuration), the UE may increase a quantity of POs (e.g., reported in the PEI) associated with a PEI configuration, where a proportionality of the increase is based on a rule.

Aspects of the disclosure are initially described in the context of wireless communications systems. Aspects are then described in the context of a process flow. Aspects of the disclosure are further illustrated by and described with reference to apparatus diagrams, system diagrams, and flowcharts that relate to techniques for adapting PEI configurations based on adaptations to paging configurations.

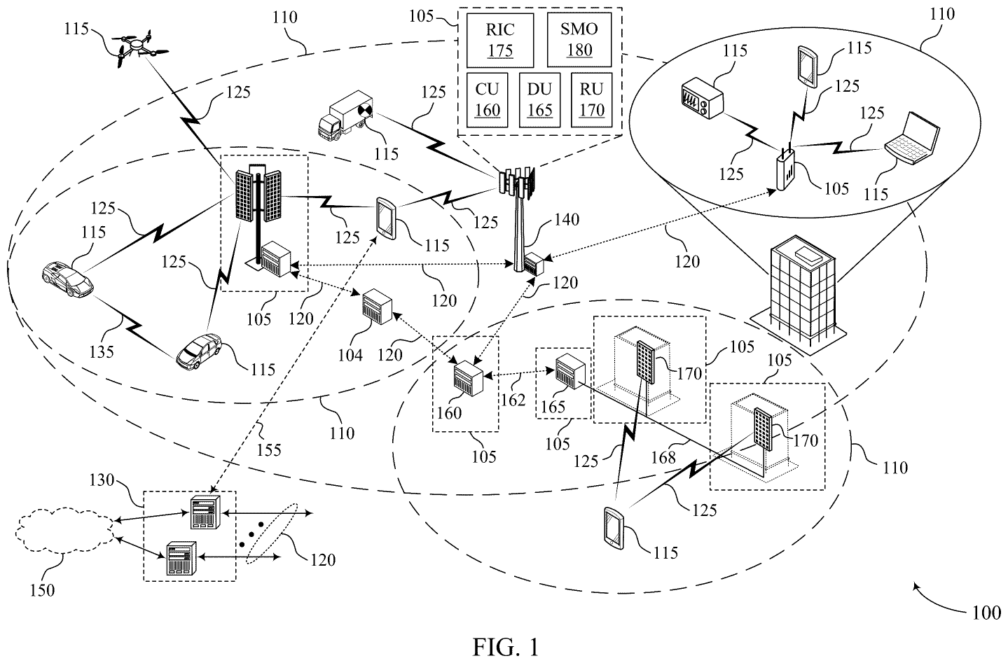

FIG. 1 shows an example of a wireless communications system 100 that supports techniques for adapting PEI configurations based on adaptations to paging configurations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-NB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 200 may support updating of PEI configurations based on a dynamic update to paging configurations. In some cases, a UE 115 may refrain from updating a PEI configuration based on an update to a paging configuration. In some other cases, the UE 115 may updating a PEI configuration based on an update to a paging configuration. For example, the UE 115 may update one or more PEI parameters of the PEI configuration to match one or more parameters of the updated paging configuration (e.g., until a threshold value is reached). Additionally, or alternatively, the UE 115 may update one or more PEI parameters of the PEI configuration based on a set of mappings between PEI configurations and paging configurations. That is, each paging configuration may be mapped to a PEI configuration, such that when a first paging configuration is updated to a second paging configuration, the UE 115 updates a first PEI configuration mapped to the first paging configuration to a second PEI configuration mapped to the second paging configuration. Additionally, or alternatively, the UE 115 may update one or more PEI parameters of the PEI configuration based on one or more rules. For example, a rule of the one or more rules may define that if a quantity of POs associated with a paging cycle is increased (e.g., based on an update to an associated paging configuration), the UE 115 may increase a quantity of POs (e.g., reported in the PEI) associated with a PEI configuration, where a proportionality of the increase is based on a rule.

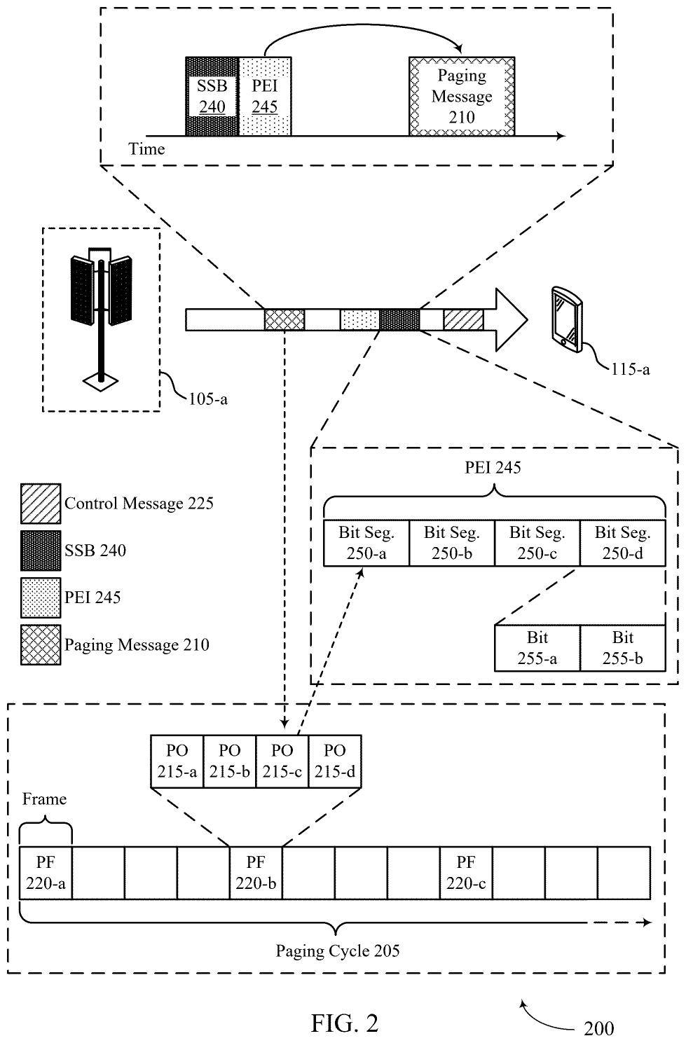

FIG. 2 shows an example of a wireless communications system 200 that supports techniques for adapting PEI configurations based on adaptations to paging configurations in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems, such as the wireless communications system 200, wireless devices, such as the UE 115-a and the network entity 105-a, may support paging. That is, the UE 115-a may operate according to a paging cycle 205, which may also be referred to as a DRX cycle, in which the UE 115-a may enter an idle, or sleep, mode, and may wake up periodically to receive one or more paging messages 210 from a second wireless device, such as the network entity 105-a, during one or more POs 215. In such cases, the paging cycle 205 may be associated with (e.g., configured according to) a paging configuration (e.g., paging configuration information). That is, the paging configuration may indicate one or more parameters associated with the paging cycle 205, such as a duration of the paging cycle 205, a quantity of PFs 220 during the paging cycle 205, a quantity of POs 215 during the paging cycle 205 (e.g., per PF 220), or the like thereof. In some cases, the network entity 105-a may transmit information related to the quantity of POs 215 during the paging cycle 205 (e.g., or other information related to POs 215 of a paging cycle 205) via an additional control message 225 (e.g., system information message).

For example, the UE 115-a may receive a control message 225 indicating a first paging configuration for a paging cycle 205, where the first paging configuration indicates that a duration of the paging cycle, ‘T,’ is 160 ms, a quantity of PFs 220 during the paging cycle 205, ‘N,’ is 4 (e.g., 4 PFs 220 per paging cycle 205), and a quantity of POs 215 during each PF 220, ‘Nₛ,’ is 4. In other words, the paging cycle 205 may include 16 frames (e.g., radio frames of 10 ms), where every 4th frame is a PF 220, such that the paging cycle 205 includes a PF 220-a, a PF 220-b, a PF 220-c, and a PF 220-d (e.g., not depicted). Additionally, each PF 220 may include 4 POs 215. For example, the PF 220-b may include a PO 215-a, a PO 215-b, a PO 215-c, and a PO 215-d.

In such cases, the UE 115-a may calculate (e.g., determine) a location of the PFs 220 within the paging cycle 205 according to the following Equation 1:

$$( {SFN}_{PF} + {PF}_{offset} ) mod ( T ) = \frac{T}{N} ( {UE}_{ID} mod ( N ) ) \qquad ( 1 )$$

where SFN_{PF} may represent an SFN (e.g., location) of a PF 220, PF_{offset} may represent an offset (e.g., PF offset) from a beginning of the paging cycle 205, and UE_{ID} may represent an identifier (ID) associated with the UE 115-a. Further, the UE 115-a may calculate a PO index, ‘iₛ,’ associated with each PO 215 according to the following Equation 2:

$${i}_{s} = floor ( \frac{{UE}_{ID}}{N} ) mod ( {N}_{s} ) \qquad ( 2 )$$

Additionally, each PO 215 may include multiple slots, where each slot is associated with transmission (e.g., potentially transmission) of an SSB 240 and includes a physical downlink control channel (PDCCH) monitoring occasion (PMO) during which the UE 115-a may monitor for a respective SSB 240. For example, the PO 215-a may include 4 slots, where each slot is associated with an SSB 240 (e.g., SSB0, SSB1, SSB2, and SSB3) and a respective PMO (e.g., a PMO #0, a PMO #1, a PMO #2, and a PMO #3, respectively).

However, the network entity 105 may not transmit a paging message 210 during each PO 215. For example, the network entity 105-a may transmit (e.g., only transmit) a paging message 210 during the PO 215-c in the PF 220-b. Thus, the network entity 105-a may transmit a PEI 245 to indicate to the UE 115-a when to wake up to receive one or more paging messages 210 (e.g., to wake up to receive the paging message 210 during the PO 215-c). For example, the UE 115-a may periodically wake up (e.g., enter an active, or connected, mode) during the paging cycle 205 to measure one or more SSBs 240 to perform time and frequency tracking (e.g., with the network entity 105-a) and the network entity 105-a may transmit a PEI 245 subsequent to (e.g., immediately after) an SSB 240 (e.g., of the one or more SSBs 240) while the UE 115-a is still awake. In such cases, the PEI 245 may indicate one or more POs 215 during which the network entity 105-a may transmit (e.g., is to transmit) one or more paging messages 210, such that the UE 115-a may return to the idle mode (e.g., after receiving the PEI 245) and subsequently wake up during the one or more indicated POs 215 to receive the one or more paging messages 210.

In some cases, a PEI 245 transmitted by the network entity 105-a may be associated with a PEI configuration (e.g., indicated to the UE 115-a via a control message 225, such as PCCH-Config), where the PEI configuration may indicate a set of PEI parameters associated with the PEI 245. That is, a PEI 245 may indicate a first quantity of POs 215, in a second quantity of consecutive PFs 220, during which the network entity 105-a may transmit one or more paging messages. As such, a PEI configuration associated with the PEI 245 may indicate the first quantity via a first PEI parameter (e.g., POnumPerPEI) of the one or more PEI parameters and may indicate the second quantity via a second PE parameter of the one or more PEI parameters. In some cases, the second quantity of consecutive PFs 220 may be 1 or 2. Additionally, or alternatively, the first quantity of POs 215 may be a factor (e.g., multiple) of a total quantity of POs 215 in a paging cycle 205, may be smaller than a quantity of POs 215 per PF 220 (e.g., Nₛ), may be a multiple of Nₛ when larger than Nₛ, or any combination thereof.

Additionally, the PEI 245 may include a third quantity of bit segments 250, where the third quantity of bit segments 250 is equal to the first quantity of POs 215 (e.g., the third quantity is equal to the first quantity). In other words, each bit segment 250 may correspond to an indicated PO 215. In such cases, each bit segment 250 may include ‘K’ bits 255. In some cases, ‘K’ may be equal to a fourth quantity of subgroups per PO 215, if subgrouping is configured via a third PEI parameter (e.g., subgroupsNumPerPO) of the set of PEI parameters, otherwise ‘K’ may be equal to 1. Thus, a size of a bitmap of the PEI 245 may be equal to the first quantity of POs 215 multiplied by the third quantity of subgroups per PO 215 (e.g., POnumPerPEI×subgroupsNumPerPO) if subgrouping is configured, otherwise the bitmap may be equal to the first quantity of POs 215 (e.g., POnumPerPEI). For example, if the first quantity of POs 215 is 4 and the third quantity of subgroups per PO 215 is 2, a PEI 245 may include a bit segment 250-a, a bit segment 250-b, a bit segment 250-c, and a bit segment 250-d, where each bit segment 250 includes a bit 255-a and a bit 255-b. Thus, as described previously, the network entity 105-a may transmit a control message 225 indicating a PEI configuration associated with a PEI 245 to enable the UE 115-a to receive the PEI 245 and to successfully determine when to wake up to receive one or more paging messages 210 based on information indicated via the PEI 245.

In some cases, the UE 115-a may receive a PEI 245 and may determine an index of a bit segment 250 associated with the UE 115-a based on an index associated with a PO 215, which may be referred to as a PO index, within the paging cycle 205 (e.g., PO index). PO indices may be consecutively counted for POs 215 across all PFs 220 within the paging cycle 205. Thus, the UE 115-a may map a PO index across all PFs 220 to a bit segment 250 based on a relative PO index within a bitmap according to the following Equation 3:

$${i}_{P O} = ( {UE}_{ID} mod ( N ) \times {N}_{s} + {i}_{s} ) mod ( POnumPerPEI ) \qquad ( 3 )$$

where ‘i_{PO}’ may represent the relative PO index, ‘N’ may represent a total quantity (e.g., number) of PFs 220 in a paging cycle 205, ‘Nₛ,’ may represent a quantity of POs 215 during each PF 220, ‘iₛ may represent an index of a PO 215 within a PF 220, ‘Nₛ,’ may represent a quantity of POs 215 during each PF 220, and ‘POnumPerPEI’ may represent a quantity of POs 215 indicated by a PEI 245. In some cases (e.g., if subgrouping is configured), the UE 115-a may determine a bit 255 within the bit segment 250 that is used as a paging indication for a subgroup of the UE 115-a based on a subgroup index, ‘i_{SG}.’ That is, the bit 255 may be equal to i_{PO}×K+i_{SG}. In other words, a PO index corresponding to a specific PO 215 within a paging cycle 205 may correspond to a bit segment 250 (e.g., bit segment 250 for the PO 215) within a PEI 245, and each bit 255 within the bit segment 250 may correspond to a subgroup (e.g., of one or more UEs 115), such that a UE 115 of a specific subgroup may determine whether or not to process a paging message 210 (e.g., PDCCH) transmitted via the specific PO 215 based on a bit 255 corresponding to the specific subgroup in the bit segment 250 (e.g., corresponding to the specific PO 215). In such cases, a bit value of 1 may indicate for the UE 115 to process the paging message 210 transmitted and a bit value of 0 may indicate that the UE 115 may not (e.g., is not required to) process the paging message 210.

For example, the network entity 105-a may determine to transmit, to the UE 115-a, associated with a first subgroup of two subgroups, a paging message 210 during the PO 215-c in the PF 220-b. Thus, the network entity 105-a may transmit, to the UE 115-a, a PEI 245 indicating for the UE 115-a to process the paging message 210 transmitted during the PO 215-c. That is, the bit segment 250-a may correspond to the PO 215-c in the PF 220-b, and a bit 255-a in the bit segment 250-a may correspond to the first subgroup, such that the network entity 105-a may transmit a bit value of 1 via the bit 255-a in the bit segment 250-a to indicate for the UE 115-a to process the paging message 210 transmitted via the PO 215-c in the PF 220-b.

In some cases, to support network energy savings, the network entity 105-a and the UE 115-a may support dynamic updates (e.g., adaptations) of paging configurations (e.g., paging configuration information). That is, as described previously, a first paging configuration may indicate one or more of a first duration of a first paging cycle 205, a first quantity of PFs 220 during the first paging cycle 205, a first quantity of POs 215 during the first paging cycle 205 (e.g., per PF 220), or the like thereof, and the UE 115-a (e.g., and the network entity 105-a) may update the first paging configuration to a second paging configuration (e.g., updated paging configuration) for a second paging cycle 205, where the second paging configuration indicates one or more of a second paging cycle 205, a second quantity of PFs 220 during the second paging cycle 205, a second quantity of POs 215 during the second paging cycle 205 (e.g., per PF 220). In some cases, the UE 115-a may update the first paging configuration to the second paging configuration based on a control message 225 (e.g., from the network entity 105-a) indicating the second paging configuration, autonomously (e.g., based on one or more conditions, based on one or more rules), or both.

However, one or more PEI parameters associated with a PEI configuration for a PEI 245 may be based on (e.g., match) a paging configuration associated with a paging cycle 205 for which the PEI 245 is transmitted. For example, as described previously, the PEI 245 may indicate the first quantity of POs 215 in the second quantity of consecutive PFs 220, where the first quantity of POs 215 is based on a total quantity of POs 215 in the associated paging cycle 205. Thus, the UE 115-a may be unaware of how or if to update a PEI configuration (e.g., one or more PEI parameters) based on an update (e.g., dynamic update) to a paging configuration.

Accordingly, techniques described herein may enable the UE 115-a to determine when and how to update (e.g., adapt) a PEI configuration based on updating (e.g., adapting) a paging configuration. For example, the UE 115-a may receive, from a network entity, a control message 225 indicating a first paging configuration for a set of paging cycles 205 (e.g., one or more paging cycles 205), including at least a first paging cycle 205. Additionally, the UE 115-a may receive a first PEI 245 associated with the first paging cycle 205 (e.g., indicating for the UE 115-a to wake up during one or more POs 215 of the first paging cycle 205) in accordance with a first PEI configuration based on the first paging configuration. In such cases, the first PEI configuration may be associated with (e.g., indicate) a first set of PEI parameters, such as a first quantity of PFs 220 per PEI 245 (e.g., 1 or 2), a first quantity of POs 215 per PEI 245 (e.g., a first POnumPerPEI), a first quantity of subgroups (e.g., a first subgroupNumPerPO), a first subgroup size, a first PEI frame offset (e.g., a first PF_{offset}, a first pei-FrameOffset), a first monitoring occasion associated per PEI 245 (e.g., a first firstPDCCH-MonitoringOccasionOfPEI-O), or any combination.

At a later time, the UE 115-a may update the first paging configuration (e.g., to a second paging configuration) for a second set of paging cycles 205, including at least a second paging cycle 205. Thus, the UE 115-a may determine whether to update the first PEI configuration (e.g., to a second PEI configuration, update the first set of PEI parameters to a second set of PEI parameters) based on updating the first paging configuration.

In some examples, the UE 115-a may determine to refrain from updating (e.g., not to update) the first PEI configuration based on updating the first paging configuration for the second set of paging cycles 205. That is, the first set of PEI parameters may remain unchanged for PEIs 245 associated with the second set of paging cycles 205. For example, the first quantity of POs 215 per first PEI 245 (e.g., the first POnumPerPEI) may stay the same for a second PEI 245 associated with the second paging cycle 205. In such cases, if the second paging configuration (e.g., new paging configuration, updated paging configuration) is associated with a quantity of POs 215 in the second paging cycle 205 that is less than the first quantity of POs 215 per PEI 245 (e.g., the first POnumPerPEI), the UE 115-a may ignore remaining POs 215 in the second PEI 245 (e.g., POs 215 indicated in a PEI 245 that do not correspond to a POs 215 in the second paging cycle 205). For example, the second paging cycle 205 may include 4 POs 215 but the second PEI 245 associated with the second paging cycle 205 may be associated with (e.g., indicate) 5 POs 215. Thus, the UE 115-a may ignore (e.g., refrain from processing) a last PO 215 indicated in the second PEI 245.

Alternatively, the UE 115-a may determine to update the first PEI configuration to a second PEI configuration based on updating the first paging configuration (e.g., to the second paging configuration) for the second set of paging cycles 205. In such cases, the second PEI configuration may be associated with (e.g., indicate) a second set of PEI parameters, such as a second quantity of PFs 220 per PEI 245 (e.g., 1 or 2), a second quantity of POs 215 per PEI 245 (e.g., a second POnumPerPEI), a second quantity of subgroups (e.g., a second subgroupNumPerPO), a second subgroup size, a second PEI frame offset (e.g., a second PF_{offset}), a second monitoring occasion associated per PEI 245 (e.g., a second firstPDCCH-MonitoringOccasionOfPEI-O), or any combination.

In some cases, the UE 115-a may update the first PEI configuration to the second PEI configuration based on a threshold value (e.g., a maximum) of one or more PEI parameters (e.g., if the maximum is reached). That is, each PEI parameter of the first set of PEI parameters and the second set of PEI parameters may be associated with a respective threshold value. Additionally, in some cases, values of PEI parameters in the first set of PEI parameters may be less than respective threshold values. Thus, the UE 115-a may update at least subset of the values of PEI parameters in the first set of PEI parameters to respective threshold values (e.g., for the second set of PEI parameters) based on updating the first paging configuration. For example, if the second paging configuration is associated with a total quantity of POs 215 in the second paging cycle 205 that is less than the first quantity of POs 215 per PEI 245 (e.g., the first POnumPerPEI), the UE 115-a may set (e.g., assume) the second quantity of POs 215 per PEI 245 (e.g., the second POnumPerPEI) equal to the total quantity of POs 215 in the second paging cycle 205.

Additionally, or alternatively, the UE 115-a may support (e.g., be configured with) more than one PEI configuration (e.g., more than one value of each PEI parameter, such as POnumPerPEI and subgroupsNumPerPO), such that the UE 115-a may activate each PEI configuration based on activation of a corresponding paging configuration (e.g., corresponding PF 220 configuration, corresponding PO 215 configuration). For example, in some cases, the first paging configuration may be associated with the first PEI configuration and the second paging configuration may be associated with the second PEI configuration, such that when the UE 115-a updates (e.g., dynamically) the first paging configuration to the second paging configuration, the UE 115-a may also update the first PEI configuration to the second PEI configuration. In other words, each paging configuration may be associated with a respective PEI configuration (e.g., respective set of PEI parameters), such that the UE 115-a may support a set of mappings between paging configurations and PEI configurations (e.g., sets of PEI parameters). In some cases, the UE 115-a may receive, from the network entity 105-a, an additional control message 225 indicating the first set of mappings. In some other cases, the UE 115-a may be preconfigured with the first set of mappings.

Additionally, or alternatively, the updates may be on per-parameter basis (e.g., a more granular level). That is, each parameter associated with a paging configuration, which may be referred to as paging parameters, may correspond to a respective PEI parameter, such that a value of a paging parameter may correspond to a value of a respective PEI parameter. For example, a first value of a paging parameter may correspond to a first value of a PEI parameter and a second value of the paging parameter may correspond to a second value of the PEI parameter, such that if updating the first paging configuration to the second paging configuration results in updating the first value of the first paging parameter to the second value of the first paging parameter, the UE 115-a may also update the first value of the PEI parameter (e.g., in the first set of PEI parameter associated with the first PEI configuration) to the second value of the PEI parameter (e.g., in the second set of PEI parameter associated with the second PEI configuration). In other words, a value of each paging parameter may be associated with a value of a respective PEI parameter, such that the UE 115-a may support a second set of mappings between values of paging parameters and values of PEI parameters. In some cases, the UE 115-a may receive, from the network entity 105-a, an additional control message 225 (e.g., the same or different than the additional control message 225 indicating the first set of mappings) indicating the second set of mappings. In some other cases, the UE 115-a may be preconfigured with the second set of mappings.

Additionally, or alternatively, the UE 115-a may support one or more rules for updating the first PEI configuration based on updating the first paging configuration. For example, the first set of PEI parameters (e.g., indicated via system information) may be a baseline set of PEI parameters, such that the UE 115-a may update the baseline set of PEI parameters (e.g., to the second set of PEI parameters) based on updating the first paging configuration (e.g., to the second paging configuration) according to at least a subset of the one or more rules. For example, a first rule of the one or more rules may indicate that if updating the first paging configuration to the second paging configuration (e.g., paging adaptation, paging update) increases a quantity of PFs 220 per paging cycle 205, the UE 115-a may update the first PEI configuration to the second PEI configuration such that the second PEI 245 may indicate 2 consecutive PFs 220 instead of 1 PF 220. In other words, the first quantity of PFs 220 per PEI 245 associated with the baseline (e.g., first) set of PEI parameters may be equal to 1 and the second quantity of PFs 220 per PEI 245 associated with the second set of PEI parameters may be equal to 2 based on increasing the quantity of POs 215 per paging cycle 205

Additionally, or alternatively, a second rule of the one or more rules may indicate that if updating the first paging configuration to the second paging configuration increases a quantity of POs 215 per paging cycle 205, the UE 115-a may update the first PEI configuration to the second PEI configuration such that the second PEI 245 may indicate an increased quantity of POs 215 per PEI 245 (e.g., POnumPerPEI). In other words, the first quantity of POs 215 per PEI 245 (e.g., the first POnumPerPEI) associated with the baseline (e.g., first) set of PEI parameters may be equal to a first value and the second quantity of POs 215 per PEI 245 (e.g., the second POnumPerPEI) associated with the second set of PEI parameters may be equal to a second value, where the second value is greater than the first value, based on increasing the quantity of POs 215 per paging cycle 205. In such cases, the difference between the first value and the second value (e.g., the increase) may be proportional to the increase in the quantity of POs 215 per PEI 245 (e.g., a difference between the first paging configuration to the second paging configuration). In some cases, the UE 115-a may receive, from the network entity 105-a, an additional control message 225 indicating the one or more rules. In some other cases, the UE 115-a may be preconfigured with the one or more rules.

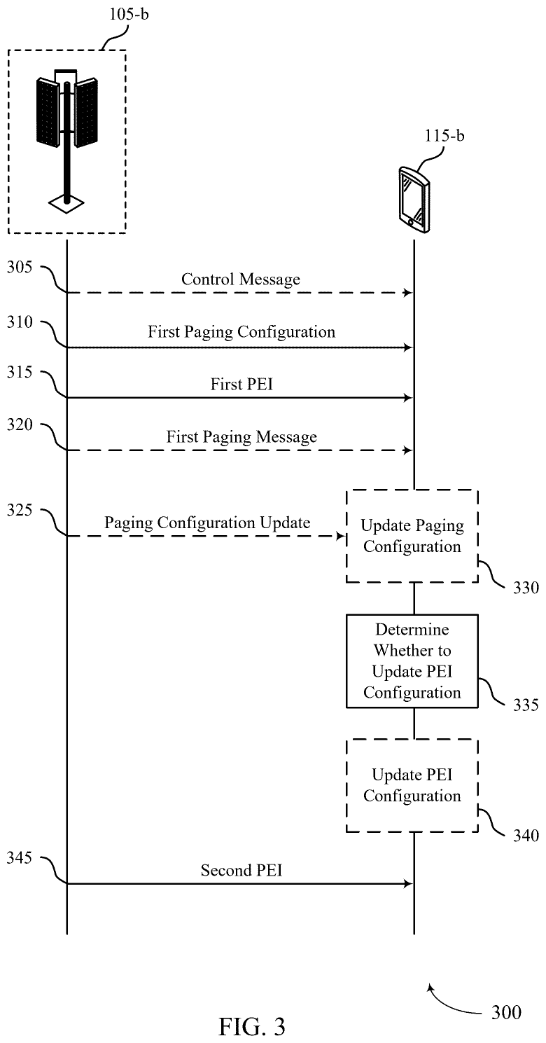

FIG. 3 shows an example of a process flow 300 that supports techniques for adapting PEI configurations based on adaptations to paging configurations in accordance with one or more aspects of the present disclosure. In some cases, the process flow 300 may implement or be implemented by aspects of the wireless communications system 100, the wireless communications system 200, or both. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 300, and other operations may be added to the process flow 300.

In some cases, at 305, the UE 115-b may receive a first control message indicating one or more rules associated with updating a first PEI parameter set, a set of mappings between multiple PEI parameter sets and multiple paging configurations (e.g., multiple paging configuration information), or both.

At 310, the UE 115-b may receive a second control message that indicates first paging configuration information, which may be referred to as a first paging configuration, associated with a first paging cycle. In such cases, the first paging configuration may indicate at least a quantity of PFs in the first paging cycle, a duration of the first paging cycle, or both.

At 315, the UE 115-b may receive a first PEI associated with the first paging cycle in accordance with the first PEI parameter set based on the first paging configuration and, at 320, may receive a first paging message during the first paging cycle based on the first PEI. In such cases, the first PEI parameter set may include a first quantity of PFs per PEI (e.g., 1 or 2), a first quantity of POs per PEI (e.g., a first POnumPerPEI), a first quantity of subgroups (e.g., a first subgroupNumPerPO), a first PEI frame offset (e.g., a first PF_{offset}), a first monitoring occasion associated with the first PEI, or any combination.

In some cases, at 325, the UE 115-b may receive a third control message that indicates a second paging configuration information associated with a second paging cycle. In such cases, the second paging configuration may be associated with an update to one or more parameters (e.g., the quantity of PFs in the first paging cycle, the duration of the first paging cycle, or both) associated with the first paging configuration.

Thus, at 330, the UE 115-b may update the first paging configuration (e.g., to an updated paging configuration). In some cases, the UE 115-b may update the first paging configuration to the second paging configuration based on the third control message. In some other cases, the UE 115-b may update the first paging configuration based on one or more conditions (e.g., autonomously).

At 335, the UE 115-b may determine whether to update the first PEI parameter set for a second PEI associated with the second paging cycle based on updating the first paging configuration for the second paging cycle. In some cases, the UE 115-b may determine not to update the first PEI parameter set for the second PEI. In some other cases, the UE 115-b may determine to update the first PEI parameter set for the second PEI. In such cases, the determining to updating the first PEI parameter set may be based on the one or more rules, the set of mappings, or both.

In some cases, at 340, the UE 115-b may update the first PEI parameter set to a second PEI parameter set for the second PEI associated with the second paging cycle based on updating the first paging configuration for the second paging cycle. In such cases, the second PEI parameter set may include a second quantity of PFs per PEI (e.g., 1 or 2), a second quantity of POs per PEI (e.g., a second POnumPerPEI), a second quantity of subgroups (e.g., a second subgroupNumPerPO), a second PEI frame offset (e.g., a second PF_{offset}), a second monitoring occasion associated with the second PEI, or any combination thereof.

In some examples, the second PEI parameter set may be based on a difference between the updated paging configuration and the first paging configuration. Additionally, or alternatively, the second PEI parameter set may be based on a first mapping, from the set of mappings, between the second PEI parameter set, from the multiple PEI parameter sets, and the updated paging configuration, from the multiple paging configurations. In such cases, the set of mappings may include, at least, a first mapping between the second PEI parameter set and the updated paging configuration and a second mapping between the first PEI parameter set, from the multiple paging early indication parameters sets, and the first paging configuration information, from the multiple paging configurations. Additionally, or alternatively, the second PEI parameter set may be based on the one or more rules associated with the difference between the updated paging configuration and the first paging configuration.

Thus, at 345, the UE 115-b may receive the second PEI based on determining whether to update the first PEI parameter set for the second PEI. In some cases, the UE 115-b may receive the second PEI associated with the second paging cycle in accordance with the first PEI parameter set based on determining to refrain from updating the PEI parameter set. In some other cases, the UE 115-b may receive the second PEI associated with the second paging cycle in accordance with the second PEI parameter set based on updating the first PEI parameter set to the second PEI parameter set (e.g., based on determining to update the first PEI parameter set).

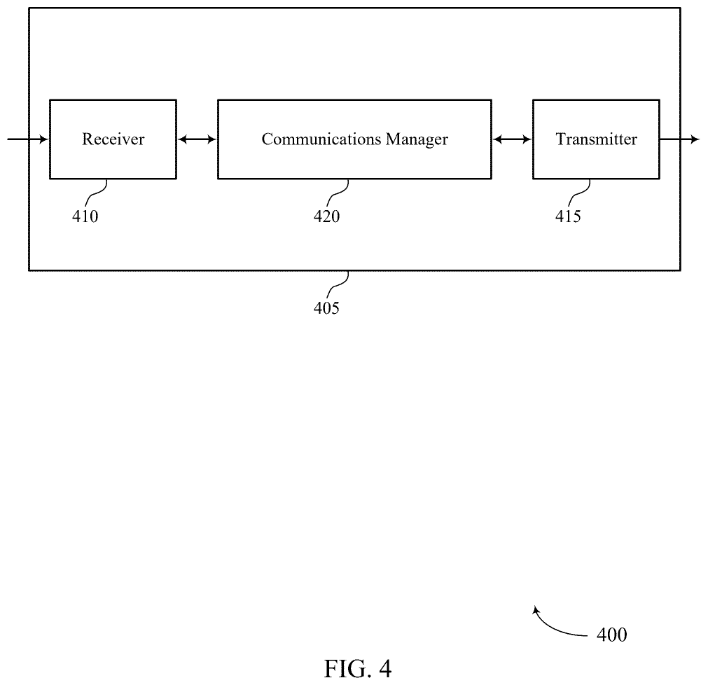

FIG. 4 shows a block diagram 400 of a device 405 that supports techniques for adapting PEI configurations based on adaptations to paging configurations in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for adapting PEI configurations based on adaptations to paging configurations). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for adapting PEI configurations based on adaptations to paging configurations). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for adapting PEI configurations based on adaptations to paging configurations as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a first control message that indicates first paging configuration information associated with a first paging cycle, where the first paging configuration information indicates at least a quantity of PFs in the first paging cycle, a duration of the first paging cycle, or both. The communications manager 420 is capable of, configured to, or operable to support a means for receiving a first PEI associated with the first paging cycle in accordance with a first PEI parameter set based on the first paging configuration information. The communications manager 420 is capable of, configured to, or operable to support a means for determining whether to update the first PEI parameter set for a second PEI associated with a second paging cycle based on updating the first paging configuration information for the second paging cycle. The communications manager 420 is capable of, configured to, or operable to support a means for receiving the second PEI based on the determining.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for adapting PEI configurations, which may result in reduced processing, reduced power consumption, and more efficient utilization of communication resources, among other advantages.

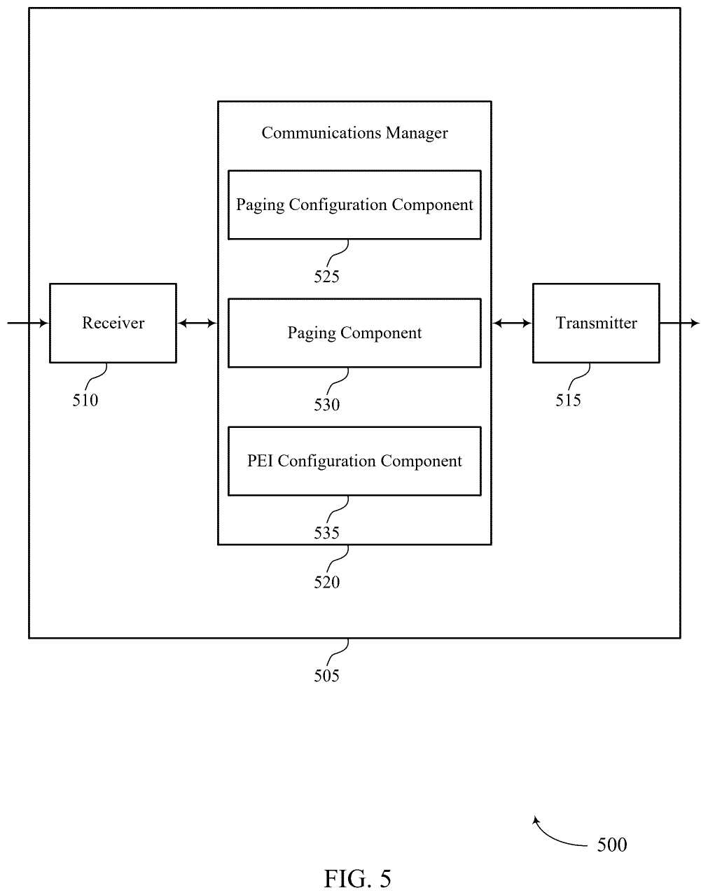

FIG. 5 shows a block diagram 500 of a device 505 that supports techniques for adapting PEI configurations based on adaptations to paging configurations in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for adapting PEI configurations based on adaptations to paging configurations). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for adapting PEI configurations based on adaptations to paging configurations). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for adapting PEI configurations based on adaptations to paging configurations as described herein. For example, the communications manager 520 may include a paging configuration component 525, a paging component 530, a PEI configuration component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The paging configuration component 525 is capable of, configured to, or operable to support a means for receiving a first control message that indicates first paging configuration information associated with a first paging cycle, where the first paging configuration information indicates at least a quantity of PFs in the first paging cycle, a duration of the first paging cycle, or both. The paging component 530 is capable of, configured to, or operable to support a means for receiving a first PEI associated with the first paging cycle in accordance with a first PEI parameter set based on the first paging configuration information. The PEI configuration component 535 is capable of, configured to, or operable to support a means for determining whether to update the first PEI parameter set for a second PEI associated with a second paging cycle based on updating the first paging configuration information for the second paging cycle. The paging component 530 is capable of, configured to, or operable to support a means for receiving the second PEI based on the determining.

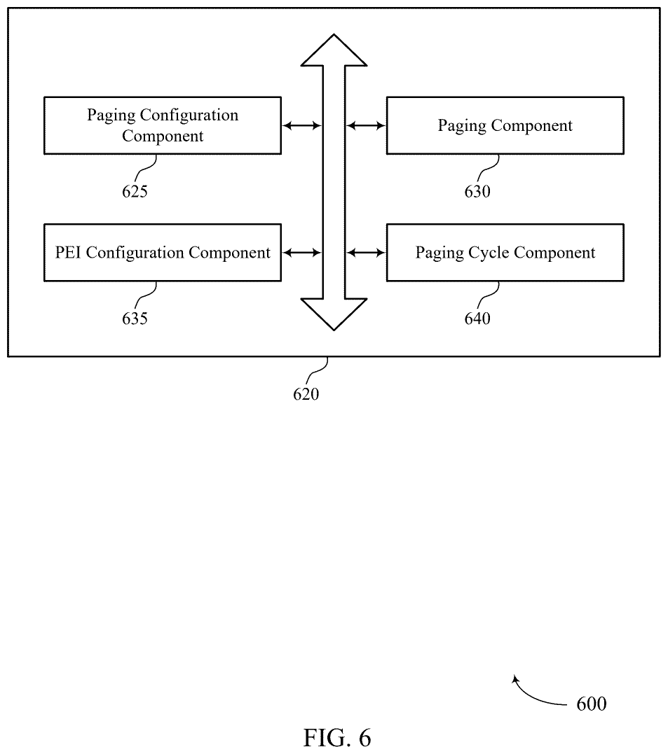

FIG. 6 shows a block diagram 600 of a communications manager 620 that supports techniques for adapting PEI configurations based on adaptations to paging configurations in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for adapting PEI configurations based on adaptations to paging configurations as described herein. For example, the communications manager 620 may include a paging configuration component 625, a paging component 630, a PEI configuration component 635, a paging cycle component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The paging configuration component 625 is capable of, configured to, or operable to support a means for receiving a first control message that indicates first paging configuration information associated with a first paging cycle, where the first paging configuration information indicates at least a quantity of PFs in the first paging cycle, a duration of the first paging cycle, or both. The paging component 630 is capable of, configured to, or operable to support a means for receiving a first PEI associated with the first paging cycle in accordance with a first PEI parameter set based on the first paging configuration information. The PEI configuration component 635 is capable of, configured to, or operable to support a means for determining whether to update the first PEI parameter set for a second PEI associated with a second paging cycle based on updating the first paging configuration information for the second paging cycle. In some examples, the paging component 630 is capable of, configured to, or operable to support a means for receiving the second PEI based on the determining.

In some examples, to support receiving the second PEI based on the determining, the paging component 630 is capable of, configured to, or operable to support a means for receiving the second PEI associated with the second paging cycle in accordance with the first PEI parameter set based on determining to refrain from updating the first PEI parameter set.

In some examples, to support determining whether to adapt the first PEI parameter set for the second PEI associated with the second paging cycle, the PEI configuration component 635 is capable of, configured to, or operable to support a means for updating the first PEI parameter set to a second PEI parameter set for the second PEI associated with the second paging cycle based on updating the first paging configuration information for the second paging cycle. In some examples, to receive the second PEI, the paging cycle component 640 is capable of, configured to, or operable to support a means for receiving the second PEI associated with the second paging cycle in accordance with the second PEI parameter set based on the adapting.

In some examples, the second PEI parameter set is based on a difference between the updated paging configuration information and the first paging configuration information.

In some examples, the PEI configuration component 635 is capable of, configured to, or operable to support a means for receiving a second control message indicating one or more rules associated with updating the first PEI parameter set, a set of mappings between a set of multiple PEI parameters sets and a set of multiple paging configuration information, or both, where determining to update the first PEI parameter set is based at at least in part on the one or more rules, the set of mappings, or both.

In some examples, the second PEI parameter set is based on a mapping, from the set of mappings, between the second PEI parameter set from the set of multiple PEI parameters sets and the updated paging configuration information from the set of multiple paging configuration information.

In some examples, the set of mappings includes a second mapping between the first PEI parameter set from the set of multiple PEI parameters sets and the first paging configuration information from the set of multiple paging configuration information.

In some examples, the second PEI parameter set is based on the one or more rules associated with a difference between the updated paging configuration information and the first paging configuration information.

In some examples, the second PEI parameter set includes a second quantity of PFs per PEI, a second quantity of POs per PEI, a second quantity of subgroups, a second PEI frame offset, a second monitoring occasion associated with the second PEI, or any combination thereof.

In some examples, the first PEI parameter set includes a quantity of PFs per PEI, a quantity of POs per PEI, a quantity of subgroups, a PEI frame offset, a monitoring occasion associated with the first PEI, or any combination thereof.

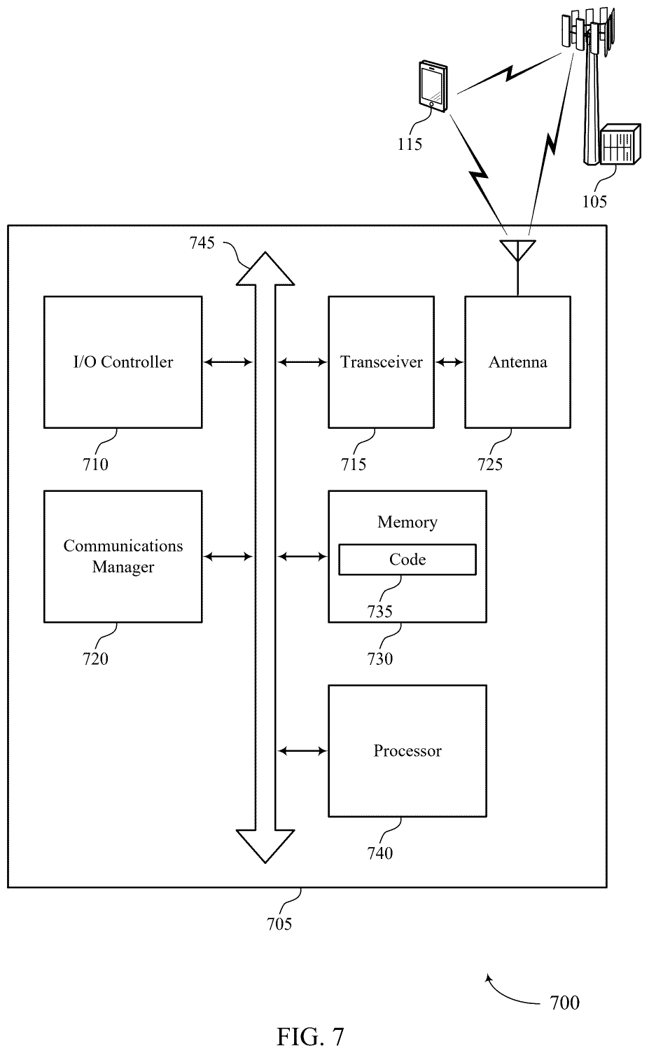

FIG. 7 shows a diagram of a system 700 including a device 705 that supports techniques for adapting PEI configurations based on adaptations to paging configurations in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for adapting PEI configurations based on adaptations to paging configurations). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a first control message that indicates first paging configuration information associated with a first paging cycle, where the first paging configuration information indicates at least a quantity of PFs in the first paging cycle, a duration of the first paging cycle, or both. The communications manager 720 is capable of, configured to, or operable to support a means for receiving a first PEI associated with the first paging cycle in accordance with a first PEI parameter set based on the first paging configuration information. The communications manager 720 is capable of, configured to, or operable to support a means for determining whether to update the first PEI parameter set for a second PEI associated with a second paging cycle based on updating the first paging configuration information for the second paging cycle. The communications manager 720 is capable of, configured to, or operable to support a means for receiving the second PEI based on the determining.

By including or configuring the communications manager 720 in accordance with examples as described herein, the device 705 may support techniques for adapting PEI configurations, which may result in improved communication reliability, reduced latency, improved user experience related to reduced processing, reduced power consumption, more efficient utilization of communication resources, improved coordination between devices, longer battery life, AND improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for adapting PEI configurations based on adaptations to paging configurations as described herein, or the at least one processor 740 and the at least one memory 730 may be otherwise configured to, individually or collectively, perform or support such operations.

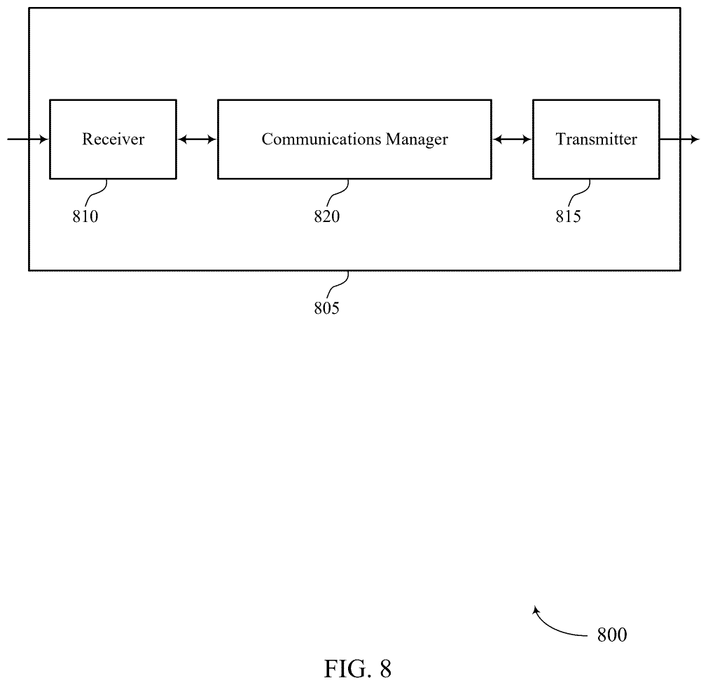

FIG. 8 shows a block diagram 800 of a device 805 that supports techniques for adapting PEI configurations based on adaptations to paging configurations in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for adapting PEI configurations based on adaptations to paging configurations as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting a first control message that indicates first paging configuration information associated with a first paging cycle, where the first paging configuration information indicates at least a quantity of PFs in the first paging cycle, a duration of the first paging cycle, or both. The communications manager 820 is capable of, configured to, or operable to support a means for transmitting a first PEI associated with the first paging cycle in accordance with a first PEI parameter set based on the first paging configuration information. The communications manager 820 is capable of, configured to, or operable to support a means for transmitting a second PEI associated with a second paging cycle in accordance with a second PEI parameter set based on updating the first PEI parameter set to the second PEI parameter set, where updating the first PEI parameter set to the second PEI parameter set is based on first paging configuration information for the second paging cycle.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for adapting PEI configurations, which may result in reduced processing, reduced power consumption, and more efficient utilization of communication resources, among other advantages.

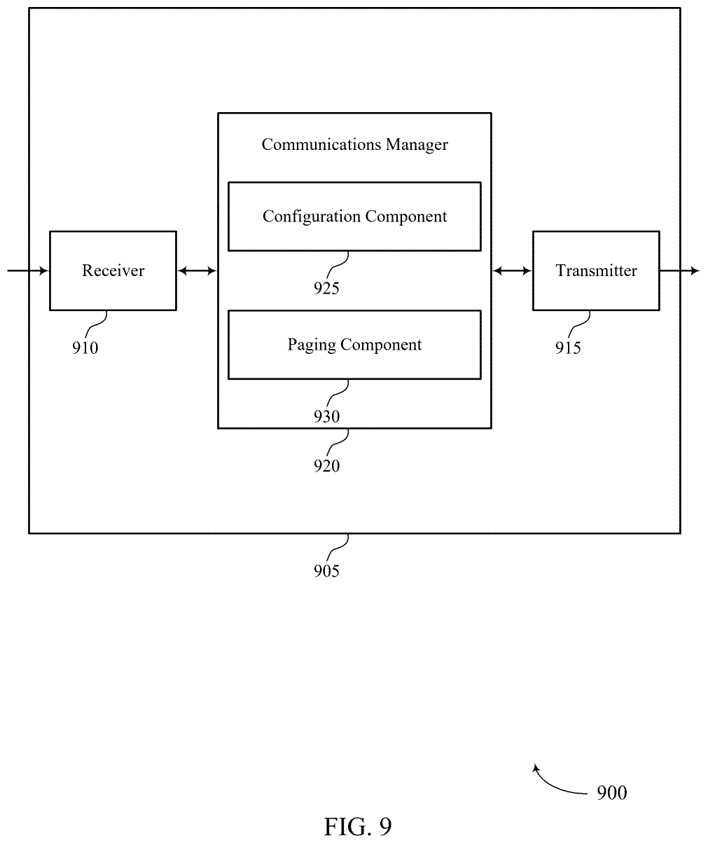

FIG. 9 shows a block diagram 900 of a device 905 that supports techniques for adapting PEI configurations based on adaptations to paging configurations in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for adapting PEI configurations based on adaptations to paging configurations as described herein. For example, the communications manager 920 may include a configuration component 925 a paging component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The configuration component 925 is capable of, configured to, or operable to support a means for transmitting a first control message that indicates first paging configuration information associated with a first paging cycle, where the first paging configuration information indicates at least a quantity of PFs in the first paging cycle, a duration of the first paging cycle, or both. The paging component 930 is capable of, configured to, or operable to support a means for transmitting a first PEI associated with the first paging cycle in accordance with a first PEI parameter set based on the first paging configuration information. The paging component 930 is capable of, configured to, or operable to support a means for transmitting a second PEI associated with a second paging cycle in accordance with a second PEI parameter set based on updating the first PEI parameter set to the second PEI parameter set, where updating the first PEI parameter set to the second PEI parameter set is based on first paging configuration information for the second paging cycle.

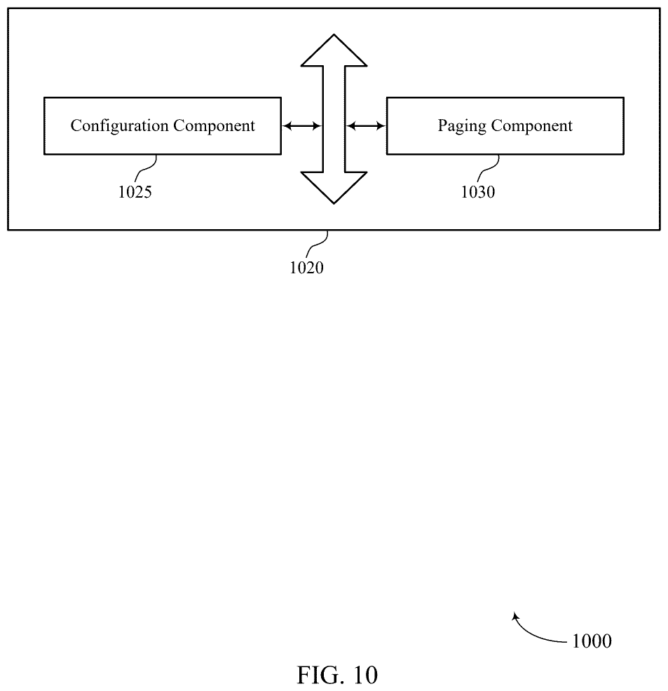

FIG. 10 shows a block diagram 1000 of a communications manager 1020 that supports techniques for adapting PEI configurations based on adaptations to paging configurations in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for adapting PEI configurations based on adaptations to paging configurations as described herein. For example, the communications manager 1020 may include a configuration component 1025 a paging component 1030, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The configuration component 1025 is capable of, configured to, or operable to support a means for transmitting a first control message that indicates first paging configuration information associated with a first paging cycle, where the first paging configuration information indicates at least a quantity of PFs in the first paging cycle, a duration of the first paging cycle, or both. The paging component 1030 is capable of, configured to, or operable to support a means for transmitting a first PEI associated with the first paging cycle in accordance with a first PEI parameter set based on the first paging configuration information. In some examples, the paging component 1030 is capable of, configured to, or operable to support a means for transmitting a second PEI associated with a second paging cycle in accordance with a second PEI parameter set based on updating the first PEI parameter set to the second PEI parameter set, where updating the first PEI parameter set to the second PEI parameter set is based on first paging configuration information for the second paging cycle.

In some examples, the second PEI parameter set is based on a difference between the updated paging configuration information and the first paging configuration information.

In some examples, the configuration component 1025 is capable of, configured to, or operable to support a means for transmitting a second control message indicating one or more rules associated with updating the first PEI parameter set, a set of mappings between a set of multiple PEI parameters sets and a set of multiple paging configuration information, or both, where determining to update the first PEI parameter set is based at at least in part on the one or more rules, the set of mappings, or both.

In some examples, the second PEI parameter set is based on a mapping, from the set of mappings, between the second PEI parameter set from the set of multiple PEI parameters sets and the updated paging configuration information from the set of multiple paging configuration information.

In some examples, the set of mappings includes a second mapping between the first PEI parameter set from the set of multiple PEI parameters sets and the first paging configuration information from the set of multiple paging configuration information.

In some examples, the second PEI parameter set is based on the one or more rules associated with a difference between the updated paging configuration information and the first paging configuration information.

In some examples, the first PEI parameter set includes a first quantity of PFs per PEI, a first quantity of POs per PEI, a first quantity of subgroups, a first PEI frame offset, a first monitoring occasion associated with the first PEI, or any combination thereof. In some examples, the second PEI parameter set includes a second quantity of PFs per PEI, a second quantity of POs per PEI, a second quantity of subgroups, a second PEI frame offset, a second monitoring occasion associated with the second PEI, or any combination thereof.

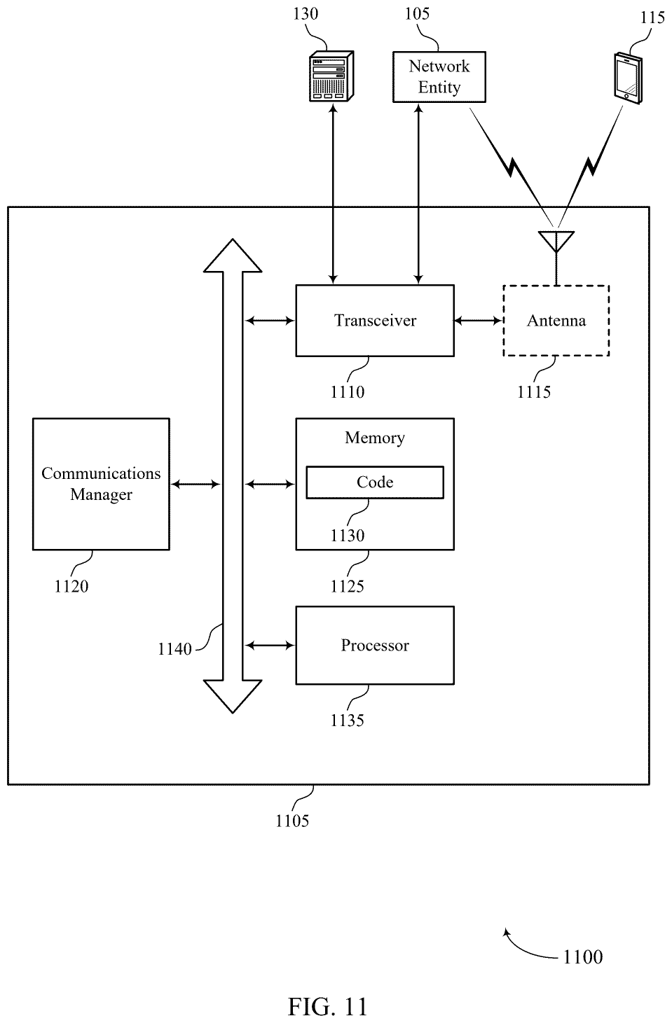

FIG. 11 shows a diagram of a system 1100 including a device 1105 that supports techniques for adapting PEI configurations based on adaptations to paging configurations in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for adapting PEI configurations based on adaptations to paging configurations). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting a first control message that indicates first paging configuration information associated with a first paging cycle, where the first paging configuration information indicates at least a quantity of PFs in the first paging cycle, a duration of the first paging cycle, or both. The communications manager 1120 is capable of, configured to, or operable to support a means for transmitting a first PEI associated with the first paging cycle in accordance with a first PEI parameter set based on the first paging configuration information. The communications manager 1120 is capable of, configured to, or operable to support a means for transmitting a second PEI associated with a second paging cycle in accordance with a second PEI parameter set based on updating the first PEI parameter set to the second PEI parameter set, where updating the first PEI parameter set to the second PEI parameter set is based on first paging configuration information for the second paging cycle.

By including or configuring the communications manager 1120 in accordance with examples as described herein, the device 1105 may support techniques for adapting PEI configurations, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for adapting PEI configurations based on adaptations to paging configurations as described herein, or the at least one processor 1135 and the at least one memory 1125 may be otherwise configured to, individually or collectively, perform or support such operations.

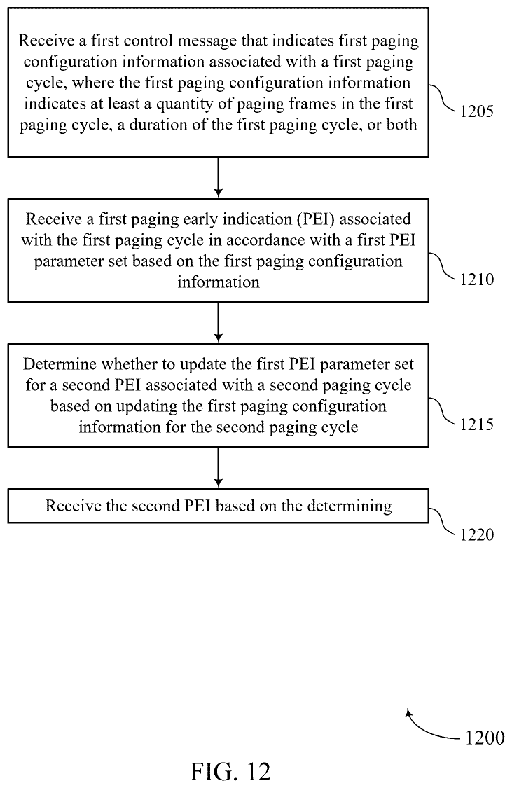

FIG. 12 shows a flowchart illustrating a method 1200 that supports techniques for adapting PEI configurations based on adaptations to paging configurations in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first control message that indicates first paging configuration information associated with a first paging cycle, where the first paging configuration information indicates at least a quantity of PFs in the first paging cycle, a duration of the first paging cycle, or both. The operations of 1205 may be performed in accordance with examples as disclosed herein. In some examples, aspects of the operations of 1205 may be performed by a paging configuration component 625 as described with reference to FIG. 6.

At 1210, the method may include receiving a first PEI associated with the first paging cycle in accordance with a first PEI parameter set based on the first paging configuration information. The operations of 1210 may be performed in accordance with examples as disclosed herein. In some examples, aspects of the operations of 1210 may be performed by a paging component 630 as described with reference to FIG. 6.

At 1215, the method may include determining whether to update the first PEI parameter set for a second PEI associated with a second paging cycle based on updating the first paging configuration information for the second paging cycle. The operations of 1215 may be performed in accordance with examples as disclosed herein. In some examples, aspects of the operations of 1215 may be performed by a PEI configuration component 635 as described with reference to FIG. 6.

At 1220, the method may include receiving the second PEI based on the determining. The operations of 1220 may be performed in accordance with examples as disclosed herein. In some examples, aspects of the operations of 1220 may be performed by a paging component 630 as described with reference to FIG. 6.

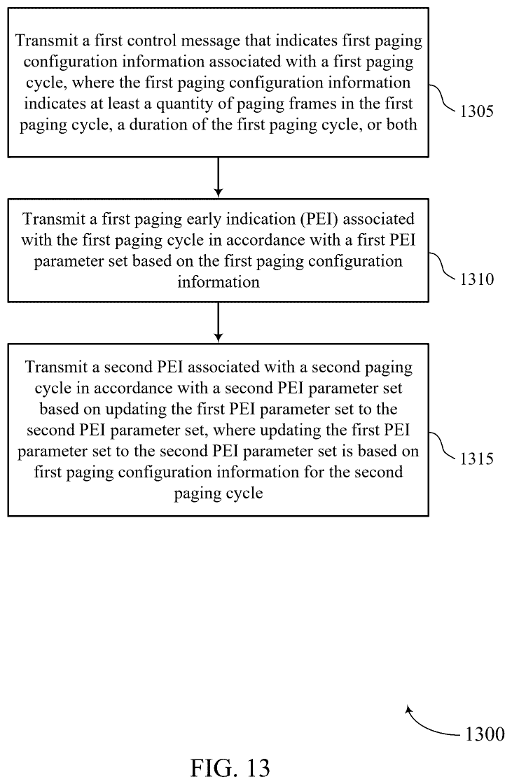

FIG. 13 shows a flowchart illustrating a method 1300 that supports techniques for adapting PEI configurations based on adaptations to paging configurations in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include transmitting a first control message that indicates first paging configuration information associated with a first paging cycle, where the first paging configuration information indicates at least a quantity of PFs in the first paging cycle, a duration of the first paging cycle, or both. The operations of 1305 may be performed in accordance with examples as disclosed herein. In some examples, aspects of the operations of 1305 may be performed by a configuration component 1025 as described with reference to FIG. 10.

At 1310, the method may include transmitting a first PEI associated with the first paging cycle in accordance with a first PEI parameter set based on the first paging configuration information. The operations of 1310 may be performed in accordance with examples as disclosed herein. In some examples, aspects of the operations of 1310 may be performed by a paging component 1030 as described with reference to FIG. 10.

At 1315, the method may include transmitting a second PEI associated with a second paging cycle in accordance with a second PEI parameter set based on updating the first PEI parameter set to the second PEI parameter set, where updating the first PEI parameter set to the second PEI parameter set is based on first paging configuration information for the second paging cycle. The operations of 1315 may be performed in accordance with examples as disclosed herein. In some examples, aspects of the operations of 1315 may be performed by a paging component 1030 as described with reference to FIG. 10.

(A summary supporting multiple-dependent claims will be added upon final approval of the claims)

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first control message that indicates first paging configuration information associated with a first paging cycle, wherein the first paging configuration information indicates at least a quantity of paging frames in the first paging cycle, a duration of the first paging cycle, or both;
receive a first paging early indication associated with the first paging cycle in accordance with a first paging early indication parameter set based at least in part on the first paging configuration information;
determine whether to update the first paging early indication parameter set for a second paging early indication associated with a second paging cycle based at least in part on updating the first paging configuration information for the second paging cycle; and
receive the second paging early indication based at least in part on the determining.

2. The UE of claim 1, wherein, to receive the second paging early indication based at least in part on the determining, the one or more processors are individually or collectively operable to execute the code to cause the UE to:
receive the second paging early indication associated with the second paging cycle in accordance with the first paging early indication parameter set based at least in part on determining to refrain from updating the first paging early indication parameter set.

3. The UE of claim 1, wherein, to determine whether to update the first paging early indication parameter set for the second paging early indication associated with the second paging cycle, the one or more processors are individually or collectively operable to execute the code to cause the UE to:
update the first paging early indication parameter set to a second paging early indication parameter set for the second paging early indication associated with the second paging cycle based at least in part on updating the first paging configuration information for the second paging cycle, wherein, to receive the second paging early indication, the one or more processors are individually or collectively operable to execute the code to cause the UE to:
receive the second paging early indication associated with the second paging cycle in accordance with the second paging early indication parameter set based at least in part on the updating.

4. The UE of claim 3, wherein the second paging early indication parameter set is based at least in part on a difference between the updated paging configuration information and the first paging configuration information.

5. The UE of claim 3, wherein the one or more processors are individually or collectively further operable to execute the code to cause the UE to:
receive a second control message indicating one or more rules associated with updating the first paging early indication parameter set, a set of mappings between a plurality of paging early indication parameters sets and a plurality of paging configuration information, or both, wherein determining to update the first paging early indication parameter set is based at at least in part on the one or more rules, the set of mappings, or both.

6. The UE of claim 5, wherein the second paging early indication parameter set is based at least in part on a mapping, from the set of mappings, between the second paging early indication parameter set from the plurality of paging early indication parameters sets and the updated paging configuration information from the plurality of paging configuration information.

7. The UE of claim 6, wherein the set of mappings comprises a second mapping between the first paging early indication parameter set from the plurality of paging early indication parameters sets and the first paging configuration information from the plurality of paging configuration information.

8. The UE of claim 5, wherein the second paging early indication parameter set is based at least in part on the one or more rules associated with a difference between the updated paging configuration information and the first paging configuration information.

9. The UE of claim 3, wherein the second paging early indication parameter set comprises a second quantity of paging frames per paging early indication, a second quantity of paging occasions per paging early indication, a second quantity of subgroups, a second paging early indication frame offset, a second monitoring occasion associated with the second paging early indication, or any combination thereof.

10. The UE of claim 1, wherein the first paging early indication parameter set comprises a quantity of paging frames per paging early indication, a quantity of paging occasions per paging early indication, a quantity of subgroups, a paging early indication frame offset, a monitoring occasion associated with the first paging early indication, or any combination thereof.

11. A network entity, comprising:
one or more memories storing processor-executable code; and
one or more processors coupled with the one or more memories and individually or collectively operable to execute the code to cause the network entity to:
transmit a first control message that indicates first paging configuration information associated with a first paging cycle, wherein the first paging configuration information indicates at least a quantity of paging frames in the first paging cycle, a duration of the first paging cycle, or both;
transmit a first paging early indication associated with the first paging cycle in accordance with a first paging early indication parameter set based at least in part on the first paging configuration information; and
transmit a second paging early indication associated with a second paging cycle in accordance with a second paging early indication parameter set based at least in part on updating the first paging early indication parameter set to the second paging early indication parameter set, wherein updating the first paging early indication parameter set to the second paging early indication parameter set is based at least in part on first paging configuration information for the second paging cycle.

12. The network entity of claim 11, wherein the second paging early indication parameter set is based at least in part on a difference between the updated paging configuration information and the first paging configuration information.

13. The network entity of claim 11, wherein the one or more processors are individually or collectively further operable to execute the code to cause the network entity to:
transmit a second control message indicating one or more rules associated with updating the first paging early indication parameter set, a set of mappings between a plurality of paging early indication parameters sets and a plurality of paging configuration information, or both, wherein determining to update the first paging early indication parameter set is based at at least in part on the one or more rules, the set of mappings, or both.

14. The network entity of claim 13, wherein the second paging early indication parameter set is based at least in part on a mapping, from the set of mappings, between the second paging early indication parameter set from the plurality of paging early indication parameters sets and the updated paging configuration information from the plurality of paging configuration information.

15. The network entity of claim 14, wherein the set of mappings comprises a second mapping between the first paging early indication parameter set from the plurality of paging early indication parameters sets and the first paging configuration information from the plurality of paging configuration information.

16. The network entity of claim 13, wherein the second paging early indication parameter set is based at least in part on the one or more rules associated with a difference between the updated paging configuration information and the first paging configuration information.

17. The network entity of claim 11, wherein the first paging early indication parameter set comprises a first quantity of paging frames per paging early indication, a first quantity of paging occasions per paging early indication, a first quantity of subgroups, a first paging early indication frame offset, a first monitoring occasion associated with the first paging early indication, or any combination thereof, and wherein the second paging early indication parameter set comprises a second quantity of paging frames per paging early indication, a second quantity of paging occasions per paging early indication, a second quantity of subgroups, a second paging early indication frame offset, a second monitoring occasion associated with the second paging early indication, or any combination thereof.

18. A method for wireless communications at a user equipment (UE), comprising:
receiving a first control message that indicates first paging configuration information associated with a first paging cycle, wherein the first paging configuration information indicates at least a quantity of paging frames in the first paging cycle, a duration of the first paging cycle, or both;
receiving a first paging early indication associated with the first paging cycle in accordance with a first paging early indication parameter set based at least in part on the first paging configuration information;
determining whether to update the first paging early indication parameter set for a second paging early indication associated with a second paging cycle based at least in part on updating the first paging configuration information for the second paging cycle; and
receiving the second paging early indication based at least in part on the determining.

19. The method of claim 18, wherein receiving the second paging early indication based at least in part on the determining comprises:
receiving the second paging early indication associated with the second paging cycle in accordance with the first paging early indication parameter set based at least in part on determining to refrain from updating the first paging early indication parameter set.

20. The method of claim 18, wherein determining whether to adapt the first paging early indication parameter set for the second paging early indication associated with the second paging cycle comprises:
updating the first paging early indication parameter set to a second paging early indication parameter set for the second paging early indication associated with the second paging cycle based at least in part on updating the first paging configuration information for the second paging cycle, wherein receiving the second paging early indication comprises:
receiving the second paging early indication associated with the second paging cycle in accordance with the second paging early indication parameter set based at least in part on the adapting.
